(19) United States
(12) Patent Application Publication
(10) Pub. No.: US 2014/0008881 A1
(43) Pub. Date: Jan. 9, 2014

(54) DEVICE FOR CONVEYING GOODS AND/OR A PERSON

(71) Applicants: Pius Ponticelli, Kappel (CH); Giulia Campanini, Parma (IT)

(72) Inventors: Pius Ponticelli, Kappel (CH); Giulia Campanini, Parma (IT)

(21) Appl. No.: 13/937,699

(22) Filed: Jul. 9, 2013

(30) Foreign Application Priority Data
Jul. 9, 2012 (DE) 20 2012 102 518.3

(51) Int. Cl. B62B 3/02

(52) U.S. Cl. CPC B62B 3/025
USPC 280/35

(57) ABSTRACT

A conveying device comprising a first support element, a second support element having a seat surface, and a support structure for mounting the second support element in a pivotable lockable configuration on the first support element.

### BACKGROUND OF THE INVENTION

Various types of devices for conveying people are known from the prior art. In this context, reference is made to, for example, DE 20 2010 008 211 U1. There, a mobile children's toy, in particular a two-wheeler or a three-wheeler, having a removable seat, is characterized in that the seat has a support device which is designed to fasten the seat, which has been removed from the children's toy, on a table top.

In DE 20 2011 051 437 U1, in turn, a device for conveying a person is shown, the device being of a foldable design.

The object of the invention is to provide a device which makes it possible in a simple and practical manner for a person and/or goods to be conveyed together and for the user to gain the greatest flexibility possible in this case. When required, the device should be rapidly and easily available for use and, when not in use, be capable of being stored rapidly and in a space-saving manner.

### SUMMARY OF THE INVENTION

The foregoing object is achieved by providing a conveying device for the conveying of a person. The conveying device comprises a vehicle, wherein the term vehicle in this context refers to two-wheelers, three-wheelers or four-wheelers. Person in this context refers to persons of a minimum age and capability who are able to hold themselves on the device using their own strength without the risk of falling off.

An exemplary embodiment according to the invention has a support frame. This support frame is formed by a first support element and a second support element, the second support element being attached to the first support element by a joint at approximately the center of the entire length of the first support element. The joint forms a fixed pivot. The two support elements are pivotably connected to one another at the fixed pivot. On account of the pivoting movement of the second support element that is possible in relation to the first support element, it is achieved that the device is foldable. Folded in this context means that the second support element can be pivoted toward the first support element. Space-saving storage of the device when not in use is advantageous here.

The joint here is encased in a support structure. The support structure is attached to the first support element. The second support element here is lockable by a fixing device in various positions in relation the first support device. For this, the user need only operate a button in order to release an already selected position. Subsequently, by pivoting the second support element in relation to the first support element, the user can lock the second support element in another defined position.

In a preferred exemplary embodiment, this occurs in that spring pins are embedded in the support structure, said spring pins being pushed into the support structure by operation of the button and thus releasing the second support element in such a manner that bores of the second support element are no longer blocked by the spring pins. Thus the second support element can be pivoted along the support structure. This may occur, for example, until other spring pins engage in the vacated bores of the second support element and in this manner lock the second support element in a defined position in relation to the first support element.

In a preferred exemplary embodiment, the pivoting movement is possible such that the castor elements of the second support element are pivotable away from the wheels of the first support element by up to 90°. It is also possible, however, that a pivoting movement of up to 180° can be carried out.

The first support element here is usually configured such that the goods to be conveyed and at least a part of the weight of the person to be conveyed should be supported. The second support element, on the other hand, serves almost entirely to support the weight of the person to be conveyed. To this end, the second support element forms a rolling connection with the ground and supports the weight of the person to be conveyed against the ground.

The device according to the invention is preferably configured such that the first support element is of tubular shape. This means that a tubular construction is provided. Further telescopic guide bars are provided inside the first support element, said guide bars being arranged so as to be displaceable in relation to one another and collectively extendable from the first support element and lockable in defined positions. The second support element, on the other hand, represents a structure substantially manufactured from two tubular strands.

The first support element has a first guide bar which is telescopically retractable into the first support element. This means, in particular, that the first guide bar is partly or fully retractable into the first support element. It is advantageous here that, when not in use, space may be saved in a simple manner.

Further, a second guide bar is encased within the first guide bar, said second guide bar in turn substantially being fully extendable from and retractable again into the first guide bar. In this manner, it is also advantageously achieved that space may be saved in that the first guide bar and the second guide bar can be slid into the first support element when the device is not in use.

Furthermore, the device according to the invention has a first locking arrangement on the first guide bar. The first locking arrangement serves to lock the first guide bar in the first support element. The second guide bar further has a second locking arrangement. The second locking arrangement serves to lock the second guide bar in the first guide bar. In this context, it is in particular the telescopic movement of the guide bars in the first support element that should be lockable. This may occur, in particular, by an operative connection between spring pins and bores, wherein the spring pins of the first support element may be formed to be engageable in bores of the first guide bar and the spring pins of the first guide bar may be formed to be engageable in bores of the second guide bar. A reversed arrangement of bores and spring pins is possible, just as is a combination of the two arrangements.

In a preferred exemplary embodiment, the two tube strands are connected to one another at a junction, the junction preferably being formed close to the joint between the first and the second support element. This leads to an improved weight distribution and facilitates the use of the device according to the invention. Besides, this construction is advantageous in that it enables a simple and stable structure.

The device according to the invention further has a castor element. The number of castor elements in particular depends on whether a two-wheeler, three-wheeler or four-wheeler, for example, is to be configured in the device. A particularly preferred exemplary embodiment is a four-wheeler. It is advantageous in this embodiment in particular that sufficient stability is achieved by the wheels and castor elements of said embodiment, the castor elements being available for steering the entire device. In one exemplary embodiment, the castor elements of the second support element are rotatably mounted for this purpose. A rotatable mounting here refers to the castors being rotatable by up to 360° about an assigned pivot axle. In addition, wheels are also provided which are rigidly suspended and serve for the easy conveyance of goods. To this end, the wheels in their state of use are located between the goods to be transported and the ground, and the castor elements are located between the seat and the ground.

Plastic-metal wheels, such as are already used for example in scooters, roller skates or rollerblades, are usually specified as wheels or castor elements, respectively. Size and circumference of the castor elements used may vary and depend on the requirements of the individual device according to the invention. Castor elements of rollerblades are in particular advantageous on account of the favorable availability paired with good running characteristics and low noise emission. A combination of different types of castor elements, for example for the first support element and the second support element, is also included in the concept of the invention. It is advantageous in this context that, depending on the use of the first support element for light or heavy goods or of the second support element for light or heavy persons, an adjustment may be made.

A particularly preferred exemplary embodiment of a device according to the invention also has a seat. This seat may be padded or unpadded. It may consist of plastic or metal and be of any shape and size, as long as it conforms to the overall requirements of the device. It is advantageous that the seat provides the comfortable possibility of conveying a person. The seat is to be configured such that it is of little weight on the one hand and, on the other hand, allows the person to be conveyed to mount and dismount in a simple manner.

The seat here is connected to the support structure in such a manner that the support structure offers sufficient support for the seat in order to ensure a safe sitting position for the person.

In another exemplary embodiment it is also conceivable that both support elements can be either rod-shaped support elements or both support elements can be formed as support elements having in each case two tubular strands. It is simply advantageous in the preferred embodiment that a very stable structure is achieved by simple means which are available at reasonable cost.

In another preferred exemplary embodiment, the device according to the invention has a foot rest. This foot rest serves to accommodate the feet of the person to be conveyed. The foot rest here is preferably attached to either of the two or to both support elements. In a particularly preferred exemplary embodiment, the foot rest is attached between a first castor arm and a second castor arm of the second support element. The foot rest here forms a stabilizing transverse connection between the two castor arms. It is advantageous in the case of the foot rests that the person to be conveyed can place and rest their feet thereon during conveyance. A further advantage can be seen in that the feet do not exert any braking action on the user of the device as a result of being dragged along the ground.

In another exemplary embodiment of the invention, the first guide bar of the first support element has a holding grip which may form, for example, a bar shape or a semi-circular shape. The holding grip may, however, also be formed in a T-shape. Shape and dimension of the holding grip depend on the requirements to be met, which lie in the person to be conveyed having a means of holding on.

In addition, the second guide bar has a pulling grip. The pulling grip is fixedly attached to the second guide bar. It serves to facilitate the pulling of the device according to the invention by the user. The pulling grip may be formed in a bar shape or a semi-circular shape.

In the exemplary embodiment according to the invention, the first support element is configured such that a case or a basket can be attached on and detached again from the first support element. This may occur by, for example, clipping on the case or the basket. For this purpose, the case or the basket may have a recess which corresponds to the shapes of the first support element in such a manner that the case or the basket can be clipped onto the first support element directly below the seat. Besides, it is possible that the case or the basket may be detachably connected in another manner to the second support element. This may occur, for example, by fastening with a strap or a rubber band, right up to a using other types of detaching mechanisms. In this context it should simply be considered that a purely manual attachment and detachment without the use of tools should be possible. Below the seat in this context refers to the region between seat and castor elements of the first support element.

The case or the basket, including the first and second support element and the associated parts, when not in use preferably has dimensions which permit it to be carried on an aircraft as hand luggage. The case is accordingly configured somewhat smaller than the permissible dimensions of hand luggage such that the case or the basket, including the first and second support element including the other features according to the invention, can be carried as hand luggage.

### BRIEF DESCRIPTION OF THE DRAWINGS

Further advantages, features and details of the present invention are described with reference to the description of an exemplary embodiment. For this purpose, figures are used, in which:

FIG. 1 is a side view from diagonally above of a device according to the invention;

FIG. 2 is a view from diagonally behind of a device according to the invention having a case;

FIG. 3 is a further view of FIG. 2 from diagonally in front;

FIG. 4 is a view from diagonally behind of another application according to the invention of the device according to the invention;

FIG. 5 is another view of the device in FIG. 4 from diagonally in front;

FIG. 6 is a side view of the device according to FIGS. 4 and 5;

FIG. 7 is a rear view of the device according to FIGS. 4 and 5; and

FIG. 8 is a side view of the fully retracted device according to the invention according to FIGS. 6 and 7.

In principle, one and the same exemplary embodiment is to be explained here. Hence every feature and its associated reference sign will not be repeated with reference to each figure within the scope of the narrative. It is expressly stated that a narrative once made with reference to a feature also applies, with the corresponding reference sign being maintained, to further figures, as long as the same feature is described with the same reference sign.

### DETAILED DESCRIPTION

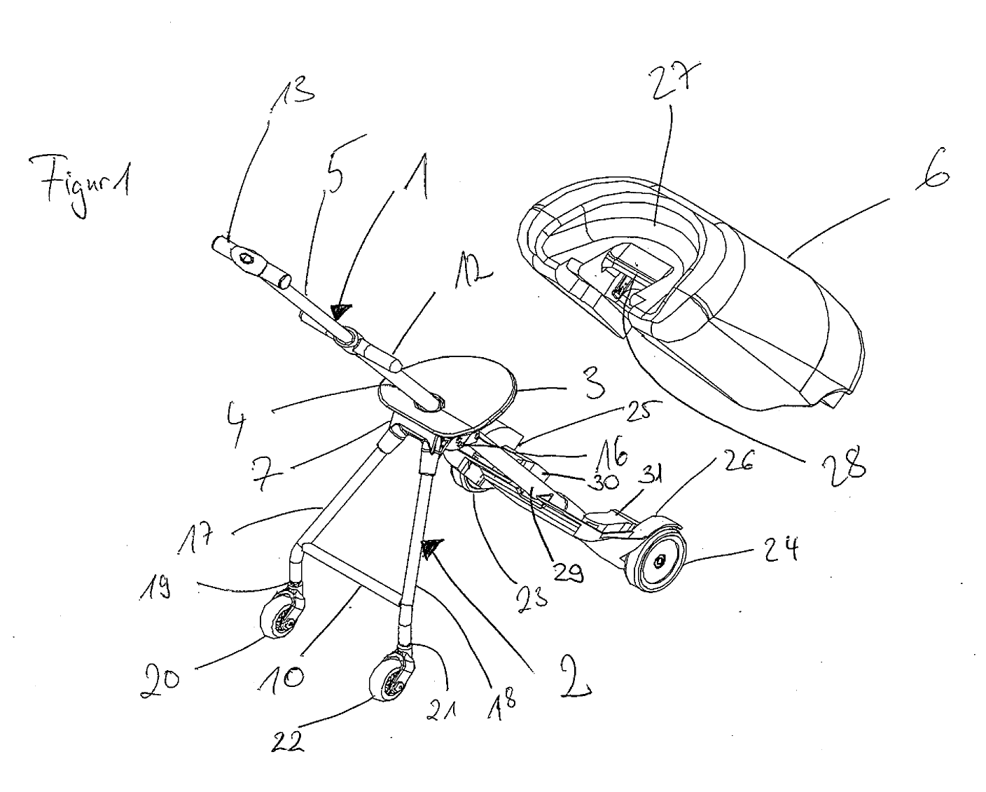

In FIG. 1, a device according to the invention is shown. This device according to the invention primarily consists of a first support element 1, a second support element 2, and a seat 3. The first support element 1, the second support element 2 and the seat 3 have a common support structure 7.

The support structure 7 is identifiable below the seat 3. The support structure 7 is fixedly connected to the first support element 1. This is evident with reference to the screw connections 16.

The first support element 1 comprises a first guide bar 4 and a second guide bar 5, the first guide bar 4 and the second guide bar 5 possibly being arranged in a telescopic configuration inside the first support element 1. In the view shown in FIG. 1, the first guide bar 4 and the second guide bar 5 are shown in the extended position. This means that the original length of the first support element 1 has been almost doubled.

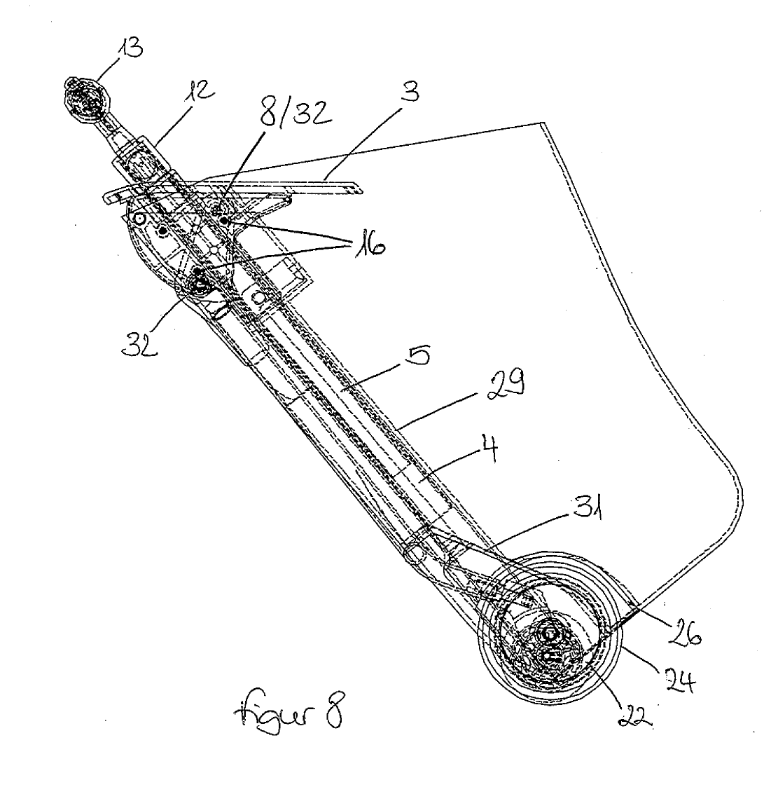

The support element 1, having first guide bar 4 and second guide bar 5, in turn is arranged in a telescopic configuration inside a guide tube 29. The guide tube 29 is clearly identifiable in particular in FIGS. 6 and 7.

The first guide bar 4 has a holding grip 12 and the second guide bar 5 has a pulling grip 13. The holding grip 12 serves the purpose of providing a person sitting on the seat 3 with a means of holding on. The pulling grip 13 serves to improve pulling of the device according to the invention by a user.

In addition, FIG. 1 shows that the second support element 2 consists of a first tube strand 17 and a second tube strand 18.

Between the first tube strand 17 and the second tube strand 18, a foot rest 10 is arranged thereon such that a person sitting on the seat 3 could place their feet on the foot rest 10 without major difficulties.

In addition, the first tube strand 17 has a castor element 20 at the end opposite the support structure 7, said castor element 20 being configured to be pivotable by 360° by means of an associated swivel joint 19. In the same manner, a castor element 22 is provided on the second tube strand 18 at the end opposite the support structure 7, said castor element 22 also being pivotable by 360° by means of an associated swivel joint 21.

FIG. 8 shows the device with reference to the above-described features when both the first guide bar 4 and the second guide bar 5, i.e. the first support element 1, is retracted into the guide tube 29. Moreover, the second support element 2, consisting of the first tube strand 17 and the second tube strand 18, is folded in and bears on the guide tube 29. The castor elements 20 and 22 here are accommodated in corresponding receptacles 30 and 31 which are located in a locking bar 9. The locking bar 9, in turn, is located between two wheels 23 and 24.

The two wheels 23 and 24 are located, at the end opposite the pulling grip 13, on the first support element 1, or the guide tube 29, respectively. The first wheel 23 has a cover 25 and the second wheel 24 has a cover 26.

In the exemplary embodiment shown here, the second support element is arranged in a pivotable configuration about a pivot axle 32 on the first support element 1, or the support structure 7, respectively. Thus, a pivoting of the second support element 2 may occur on the support structure 7. This is above all possible because of the support structure 7 being fixedly connected to the first support element 1.

The second support element 2 is arranged in a pivotable configuration on the support structure 7 via a spring pin/bore construction 8. An interaction of spring pins and bores (not shown), referred to as fixing device, permits the locking of the second support element 2 in predefined swivel positions in relation to the first support element 1.

To this end, the user need only operate a button (not shown) in order to release an already selected position. By operating the button, a spring pin of the support structure 7 is pushed out of the locking bore of the second support element 2, such that the second support element 2 may be pivoted on the support structure 7. Subsequently, the user may lock a defined position by pivoting the second support element 2, for example in the direction of the first support element 1, in that said user positions other spring pins (also not shown) by slipping over the second support element 2 and subsequent engagement into the bore of the second support element 2.

In order to then again effect a release of the second support element 2, the user again needs to operate the button (not shown) in order to push the spring pins into the support structure 7 and to thus unlock the second support element 2. For a pivoting movement of the second support element 2 on the support structure 7 to be possible, the second support element 2 has the pivot axle 32 in the support structure 7.

It is further evident in FIG. 1 that a case 6 has a recess 27 which is adapted to the seat 3 for accommodating said seat 3. Besides, the case 6 displays a clip-on device 28 (not described in more detail) by which the case 6 can be clipped onto the first support element 1 of the device according to the invention between the seat 3 and the wheels 23 and 24.

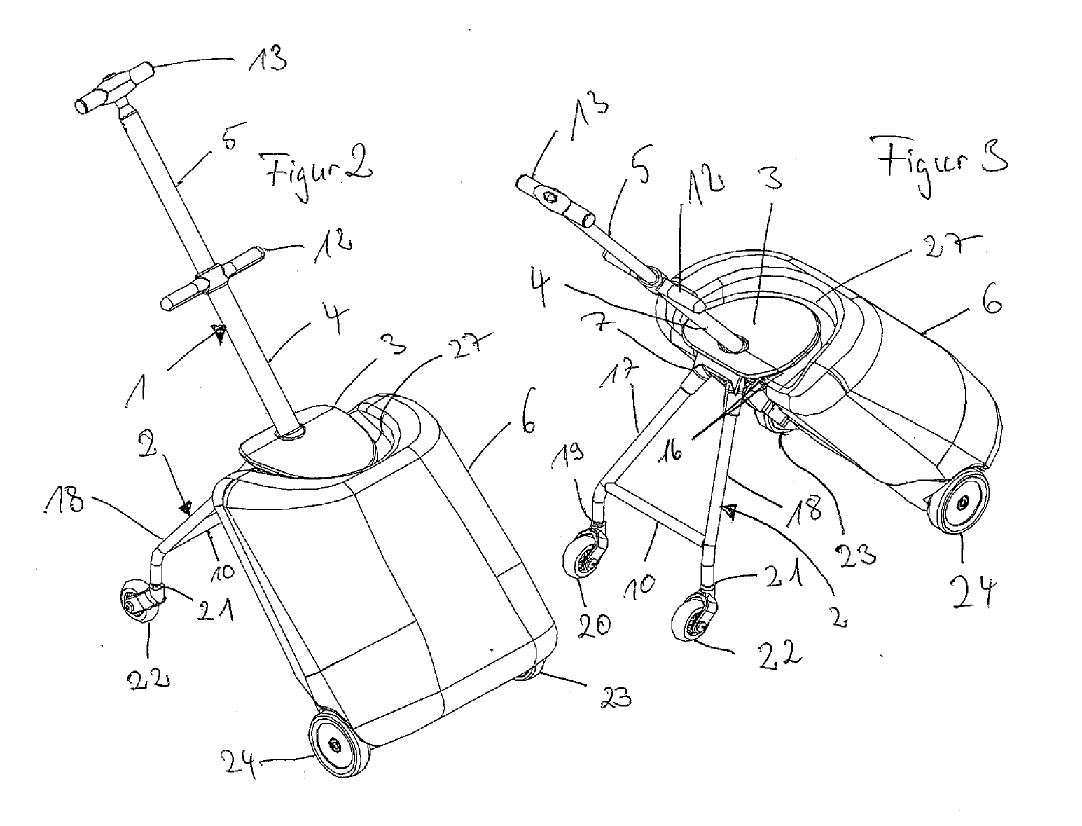

FIG. 2 now shows the case 6 clipped onto the first support element 1. It is evident there that the seat 3 protrudes into the recess 27. Moreover, it is again clearly visible how the second guide bar 5 is telescopically mounted in the first guide bar 4. A repeat of the narrative from FIG. 1 is dispensed with in respect of the individual reference signs. Rather, the statements made in FIG. 1 concerning the identically named features are considered as being disclosed also in respect of FIG. 2.

In FIG. 3, another view of FIG. 2 is evident.

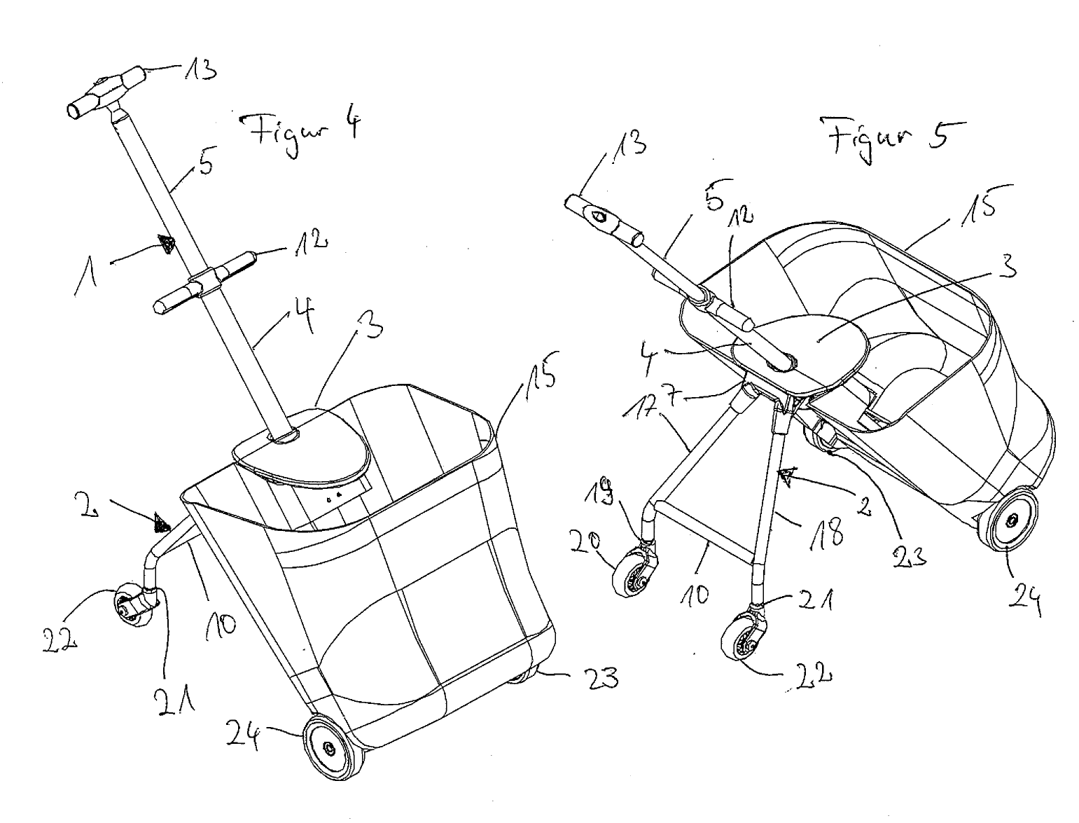

In FIG. 4, in turn, instead of the case 6, a basket 15 is clipped onto the first support element 1. The basket 15 is again attached between the seat 3 and the wheels 23 and 24.

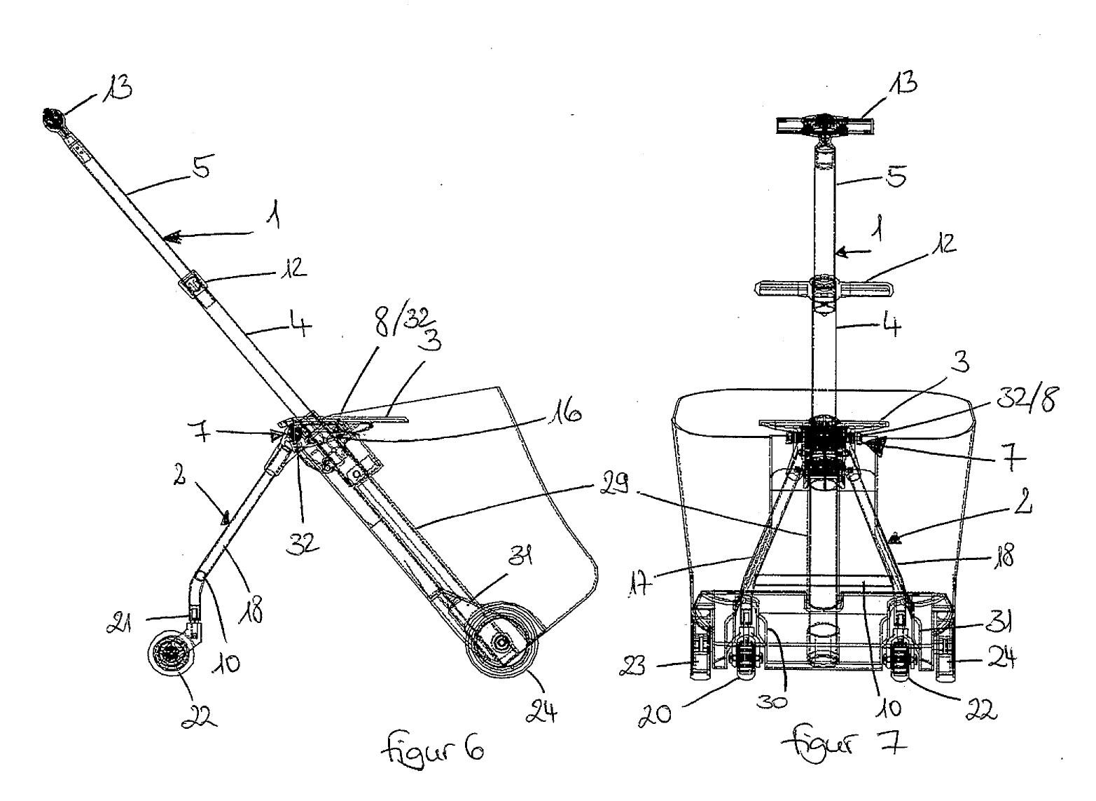

FIG. 5 shows another view of FIG. 4.

FIGS. 6 and 7 show a side view of the device, and a rear view of the device, respectively.

In FIG. 8, in turn, a side view of the fully retracted device according to the invention is shown.

1. A conveying device comprising:
a first support element;
a second support element having a seat surface; and
a support structure for mounting the second support element in a pivotable lockable configuration on the first support element.

2. A device according to claim 1, wherein the first support element has a wheel and the second support element has a castor element.

3. A device according to claim 1, wherein the second support element has a foot rest.

4. A device according to claim 2, wherein the first support element has a main tube in which a first guide bar is provided in a telescopic configuration.

5. A device according to claim 4, wherein a second guide bar is telescopically received in the first guide bar.

6. A device according to claim 5, wherein the first guide bar is releasably lockable in the main tube, and the second guide bar is releasably lockable in the first guide bar.

7. A device according to claim 4, wherein the first guide bar has a holding grip.

8. A device according to claim 5, wherein the second guide bar has a pulling grip.

9. A device according to claim 1, wherein a case or a basket is detachably mountable on the first support element.

10. A device according to claim 1, wherein the first support element penetrates through the seat.

11. A device according to claim 1, wherein the second support element is pivotably lockable on the first support element at an angle of 0° to 180°.
